(19) United States
(12) Patent Application Publication
(10) Pub. No.: US 2008/0143667 A1
(43) Pub. Date: Jun. 19, 2008

(54) Surface light source device and backlight unit having the same

(75) Inventors: Yong Keun Jee, Suwon-si (KR); Hun Suk Yoo, Suwon-si (KR); Hwan Woong Lee, Suwon-si (KR); Sang Soo Hwang, Suwon-si (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Samsung Corning Co., Ltd., Suwon-si (KR)

(21) Appl. No.: 12/001,211

(22) Filed: Dec. 10, 2007

(30) Foreign Application Priority Data
Dec. 11, 2006 (KR) 10-2006-0125843
Oct. 17, 2007 (KR) 10-2007-0104494

(51) Int. Cl. G09G 3/36

(52) U.S. Cl. 345/102

(57) ABSTRACT

There is a provided a surface light source device comprising: a light source body having an inner space therein in which a discharge gas is contained; a plurality of electrodes formed on the light source body in such a manner as to electrically divide the inner space into at least three blocks and applying discharge voltages to the blocks; and a driving unit sequentially applying the discharge voltages to the blocks through the electrodes in synchronization with a video signal of an external display device. The light source body may have a plurality of discharge spaces or a single discharge space therein. In accordance with the present invention, the surface light source device sequentially applies the discharge voltages to the blocks, and thereby can reduce an after-image occurring in a liquid crystal display device. Further, the surface light source device is driven with a duty ratio varied depending on brightness of the video signal, and thereby integrated power consumption can be reduced and a contrast ratio can be improved.

### CROSS-REFERENCE TO RELATED APPLICATION

This application claims the benefit of Korean Patent Application No. 10-2007-0104494 filed on Oct. 17, 2007 and 10-2006-0125843 filed on Dec. 11, 2006, the disclosure of which is hereby incorporated herein by reference in its entirety.

### BACKGROUND OF THE INVENTION

1. Technical Field

The present invention relates to a surface light source device and a backlight unit having the same, and more particularly, to a surface light source device which sequentially drives a discharge space partitioned into a plurality of regions, and a backlight unit having the surface light source device as a light source.

2. Discussion of Related Art

A liquid crystal display (LCD) device displays an image, using an electrical characteristic and an optical characteristic of liquid crystal. Since the LCD device is very small in size and light in weight, compared to a cathode-ray tube (CRT) device, it is widely used for portable computers, communication devices, liquid crystal television (LCTV) receivers, aerospace industry, and the like.

The LCD device includes a liquid crystal controlling part for controlling the liquid crystal, and a backlight unit for supplying light to the liquid crystal. The liquid crystal controlling part includes a number of pixel electrodes disposed on a first substrate, a single common electrode disposed on a second substrate, and liquid crystal interposed between the pixel electrodes and the common electrode. The number of pixel electrodes corresponds to resolution, and the single common electrode is placed in opposite to the pixel electrodes. Each pixel electrode is connected to a thin film transistor (TFT) so that each different pixel voltage is applied to the pixel electrode. An equal level of a reference voltage is applied to the common electrode. The pixel electrodes and the common electrode are made of a transparent conductive material.

The light supplied from the backlight unit passes through the pixel electrodes, the liquid crystal and the common electrode sequentially. The display quality of an image passing through the liquid crystal significantly depends on luminance and luminance uniformity of the backlight unit. Generally, as the luminance and luminance uniformity are high, the display quality is improved. In a conventional LCD device, the backlight unit generally uses a cold cathode fluorescent lamp (CCFL) in a bar shape or a light emitting diode (LED) in a dot shape. The CCFL has high luminance and long life of use and generates a small amount of heat, compared to an incandescent lamp. The LED has high consumption of power but has high luminance. However, in the CCFL or LED, the luminance uniformity is weak. Therefore, to increase the luminance uniformity, the backlight unit which uses the CCFL or LED as a light source, needs optical members, such as a light guide panel (LGP), a diffusion member and a prism sheet. Consequently, the LCD device using the CCFL or LED becomes large in size and heavy in weight due to the optical members.

Therefore, a surface light source device in a flat shape has been suggested as the light source of the LCD device.

Referring to FIG. 1, a conventional surface light source device includes a light source body 10 and electrodes 20 provided at both edges of the light source body 10. The light source body 10 includes a first substrate and a second substrate which are spaced apart from each other by a predetermined distance. A plurality of partitions 30 are arranged between the first and second substrates, and partition an inner space defined by the first and second substrates into a plurality of discharge spaces 50. Between the edges of the first and second substrates, sealing members 40 are disposed to isolate the discharge spaces 50 from the exterior. A discharge gas is injected into the isolated discharge spaces 50.

The electrodes 20 are formed in a strip shape on the surface of the light source body 10 such as to have the same area over each discharge space 50. An inverter applies discharge voltages to the discharge spaces 50. All discharge spaces are uniformly discharged.

A liquid crystal display device has a drawback of an after-image due to the response characteristics of liquid crystal. The after-image in a moving picture deteriorates the display quality. As a liquid crystal display device has become bigger, the requirement for improving the display quality has more and more increased. Various approaches to solve the after-image have been made but there are still many problems to be solved.

The liquid crystal display device has the problem that excessive electric power is consumed by a backlight unit. Therefore, the reduction of power consumption has been keenly demanded. Further, since a conventional fluorescent lamp generally uses mercury as a discharge gas, there has been increased the necessity for a lamp which does not use mercury for an environmental reason, for example, the Restriction of Hazardous Substances (RoHs) Directive.

### SUMMARY OF THE INVENTION

Therefore, an object of the present invention is to provide a surface light source device and a backlight unit having the same, which improve the display quality of a liquid crystal display device.

Another object of the present invention is to provide a surface light source device and a backlight unit having the same, which reduce integrated power consumption.

Another object of the present invention is to provide a surface light source device and a backlight unit suitable for driving a surface light source device which does not use mercury as a discharge gas.

In accordance with an aspect of the present invention, the present invention provides a surface light source device comprising: a light source body having an inner space therein in which a discharge gas is contained; a plurality of electrodes formed on the light source body in such a manner as to electrically divide the inner space into at least three blocks and applying discharge voltages to the blocks; and a driving unit sequentially applying the discharge voltages to the blocks through the electrodes in synchronization with a video signal of an external display device.

The electrodes may be formed at both ends of the blocks, and the driving unit may apply anti-phase voltages to both ends of the blocks through the electrodes.

The light source body may have a plurality of discharge spaces or a single discharge space therein.

The electrodes may be locally formed on one outer surface or both outer surfaces of the light source body. The electrodes may be formed all over one outer surface or both outer surfaces in a shape of a plurality of face electrodes with a high aperture ratio.

In accordance with another aspect of the present invention, the present invention provides a backlight unit comprising: a surface light source device comprising a light source body having an inner space therein in which a discharge gas is contained, a plurality of electrodes formed on the light source body in such a manner as to electrically divide the inner space into at least three blocks and applying discharge voltages to the blocks, and a driving unit sequentially applying the discharge voltages to the blocks through the electrodes in synchronization with a video signal of an external display device; and a case to receive the surface light source device.

In accordance with the present invention, since the surface light source device has a plurality of blocks and the discharge voltages are sequentially applied to the blocks, an after-image occurring in a liquid crystal display is reduced. Furthermore, since the surface light source device is divisionally driven, power consumption is reduced, its lifetime is extended, and image quality is improved.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a plan view of a conventional surface light source device;

FIG. 2 is a block diagram for illustrating a driving unit of a surface light source device according to the present invention;

FIG. 3 is a perspective view of a surface light source device according to an embodiment of the present invention;

FIGS. 4A through 4C are graphs illustrating pulse width modulation (PWM) signals and FIGS. 4D and 4E are graphs illustrating voltage waveforms applied to a surface light source device according to the present invention;

FIG. 5 is a partially enlarged view of electrodes of FIG. 3;

FIG. 6 is a perspective view illustrating a surface light source device according to another embodiment of the present invention;

FIG. 7 is a sectional view taken along the line X-X′ of FIG. 6;

FIG. 8 is a perspective view illustrating a surface light source device according to another embodiment of the present invention;

FIG. 9 is a sectional view taken along the line Y-Y′ of FIG. 8;

FIG. 10 is a plan view and a bottom view of a surface light source device according to another embodiment of the present invention;

FIG. 11 is a plan view and a bottom view of a surface light source device according to another embodiment of the present invention; and

FIG. 12 is an exploded perspective view of a backlight unit according to the present invention.

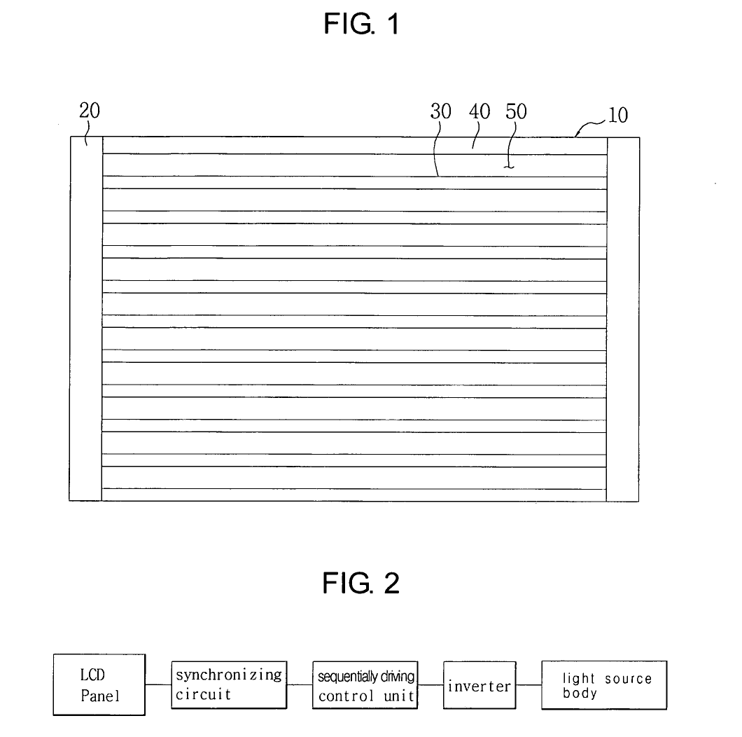

### DETAILED DESCRIPTION OF THE INVENTION

The present invention will now be described more fully hereinafter with reference to the accompanying drawings, in which preferred embodiments of the invention are shown.

The present invention has a first characteristic that an inner space in a surface light source device is physically or non-physically (by dividing an electrode) is divided into a plurality of blocks to which discharge voltages are divisionally and sequentially applied. Further, the present invention has a second characteristic that the discharge voltages are applied to the blocks in synchronization with a video signal of a liquid crystal display device.

This can significantly reduce an after image occurring in a liquid crystal display device.

FIG. 2 is a block diagram schematically illustrating a driving unit for driving a surface light source device according to the present invention. The driving unit includes a synchronizing circuit, a sequentially driving control unit and an inverter. The synchronizing circuit makes the discharge voltages applied to the discharge spaces synchronized with a video signal of a liquid crystal display (LCD) panel. The sequentially driving control unit makes the discharge voltages synchronized with, specifically, a scan signal of the video signal and thereby enables discharge voltages to be sequentially applied to blocks. The sequentially driving control unit may be an independent circuit or may be integrated with an inverter.

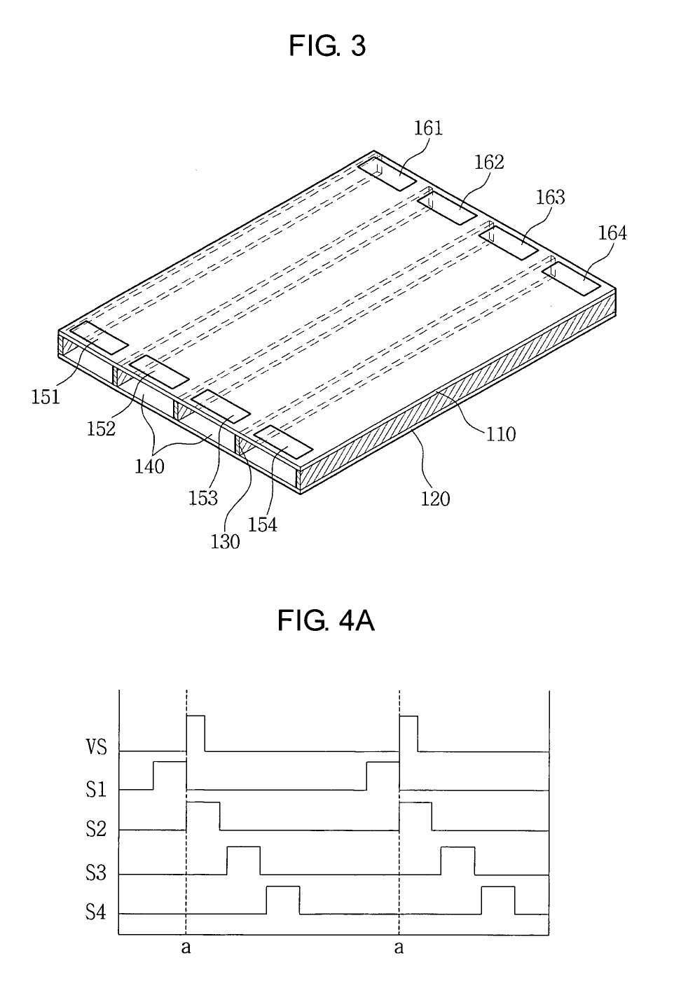

FIG. 3 is a perspective view of a surface light source device according to a first embodiment of the present invention. A light source body includes a first substrate 110 and a second substrate 120. A sealing member along edges of the light source body isolates an inner space between the first and second substrates 110 and 120 from the exterior. Partitions 130 partition the inner space into a plurality of discharge spaces 140. Electrodes 151˜154 and 161˜164 are formed on an outer surface of the surface light source device corresponding to the discharge spaces. A pair of the electrodes is formed at both ends of each discharge space. The electrodes may be formed at one outer surface or both outer surfaces of the surface light source device. Discharge voltages are sequentially applied to the discharge spaces 140 through electrodes 151˜154 and 161˜164.

Here, for example, discharge spaces (constituting a first block) to which first discharge voltages are applied may partially overlap discharge spaces (constituting a second block) to which second discharge voltages is applied.

In the present invention, the discharge voltage may have a square waveform or an impulse waveform.

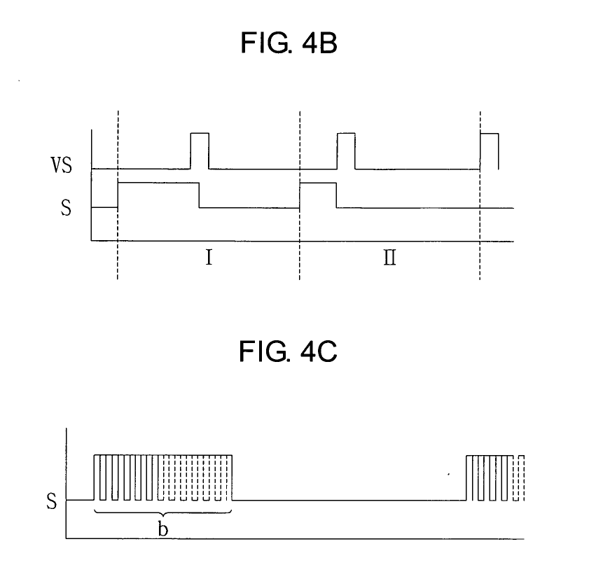

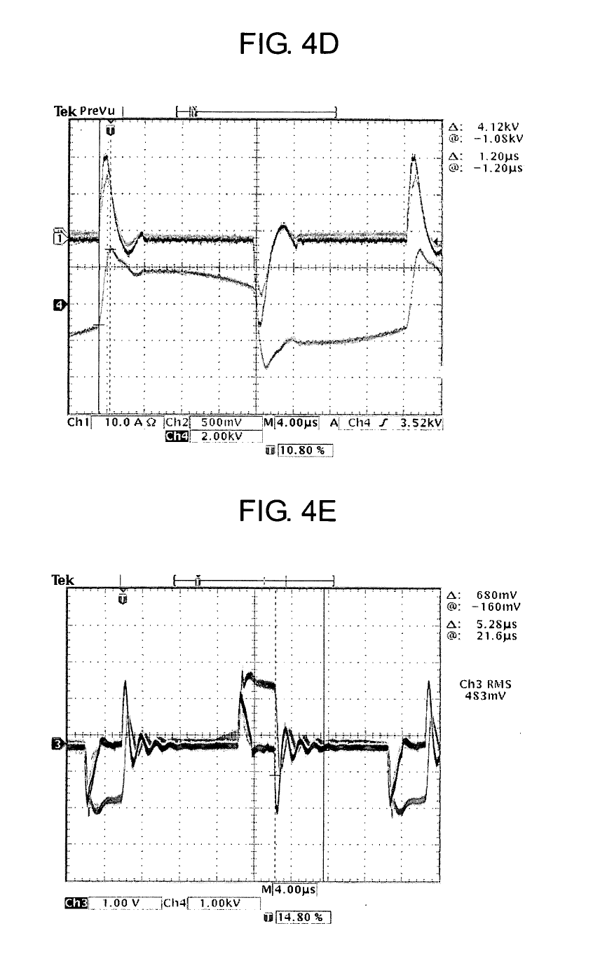

FIGS. 4A through 4C are graphs for explaining a pulse width modulation (PWM) and FIGS. 4D and 4E are graphs illustrating voltage waveforms applied to a surface light source device according to the present invention.

Referring to FIG. 4A together with FIG. 3, the discharge voltages may be sequentially applied, for example, to the first to fourth discharge spaces of the surface light source device of FIG. 3 as follows:

First discharge voltages are applied to a first discharge space 140 through first electrodes 151 and 161 according to a first PWM signal S1.

Subsequently, second discharge voltages are applied to a second discharge space 140 through second electrodes 152 and 162 according to a second PWM signal S2.

Subsequently, third discharge voltages are applied to a third discharge space 140 through third electrodes 152 and 162 according to a third PWM signal S3.

Subsequently, fourth discharge voltages are applied to a fourth discharge space 140 through fourth electrodes 152 and 162 according to a fourth PWM signal S4, whereby one cycle of applying the discharge voltages is completed.

In this manner, the surface light source device divisionally and sequentially emits light, which reduces an after image and improves the image quality.

That is, the present invention divides an inner space of a surface light source device into three or more blocks, and preferably, four or more blocks and sequentially applies the discharge voltages to the blocks, and thereby reduces an after image.

The discharge voltages may be provided by a plurality of driving units or a single common driving unit.

The sequentially driving control unit provides sequential PWM signals synchronized with a vertical frequency of a video signal, whereby the light source device can sequentially emits light in synchronization with the vertical frequency of the video signal.

Accordingly, once a scan signal is applied to a certain local area in a screen of a liquid crystal display device, light is locally provided to the local area for a certain period of time from the back by the surface light source device. Thereafter, light is not provided to the local area for another certain period of time. This improves the image quality as if a black image is inserted between actual images.

To maximize the effect of the sequential driving, as illustrated in FIG. 4A, an end point ‘a’ of the first PWM signal S1 may be coincident with a start point of the external video signal VS (vertical frequency of a liquid crystal display device). This more effectively reduces an after image occurring in a liquid crystal display device.

Further, it is preferable that a duty ratio of the pulse width modulation signal is 50% or less in order to effectively reduce an after image.

Further, a contrast ratio of an image can be improved by varying the duty ratio depending on brightness of the video signal. For example, referring to FIG. 4B, duty ratios are differently modulated in a period I (with a duty ratio of 40 to 50%) and a period II (with a duty ratio of 10 to 20%) depending on the external video signal VS, whereby the surface light source device generates different luminance lights during the period I (bright image) and the period II (dark image).

A surface light source device varies a duty ratio of a pulse width modulation signal within 10˜50% to reduce an after image. The brightness of a surface light source device is controlled depending on a video signal. Consequently, the integrated power consumption is reduced and the image quality of the liquid crystal display device is greatly improved.

Further, an effect of reducing an after image can be maximized by applying voltage pulses during an on-duty period with a duty ratio of a pulse width modulation signal fixed. Referring to FIG. 4C, a vertical frequency is 60 Hz, a duty ratio of a pulse width modulation signal is fixed within 25 to 40%, and voltage pulses (b) of 1 kHz or more are applied during an on-duty period.

The number of the voltage pulses of 1 kHz or more in an on-duty period is controllable depending on brightness of the video signal. This maximizes the effects of reducing an after image and improving image quality.

A surface light source device according the present invention can be driven by a voltage of an impulse waveform as well as a voltage of a square waveform.

When a surface light source device is driven by a voltage of an impulse waveform, a preferable frequency thereof may be within 20 to 60 kHz and a preferable on-time may be within 0.1 to 10 μs. As the on-time is shorter, discharge rise-time is faster so that the efficiency of a surface light source device increases.

FIGS. 4D and 4E show examples of waveforms of discharge voltages generated by a half bridge type inverter and a full bridge type inverter respectively, in which an on-time is within 0.1 to 10 μs.

A discharge voltage with such a waveform is applied during the on-duty period as described above.

In the present invention, a plurality of electrodes may be formed at both ends of discharge spaces. In this case, preferably, the driving unit may apply anti-phase voltages to the electrodes at both ends. That is, a phase of a voltage applied to one electrode is low and a phase of a voltage applied to the other electrode is high and thus, the sum of the voltages applied to a discharge space becomes twice.

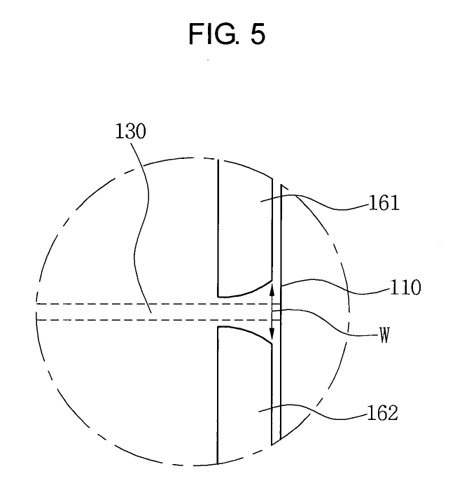

A gap between electrodes may be wider than a gap between the discharge spaces, to prevent a discharge voltage applied to one block from undesirably exerting an effect on another adjacent block during the sequential driving. Referring to FIG. 5, a gap between the electrodes 161 and 162 may be wider than a gap between discharge spaces (for example, the width of a partition 130 in FIG. 5). A gap W between the electrodes may vary depending on a gap between discharge spaces.

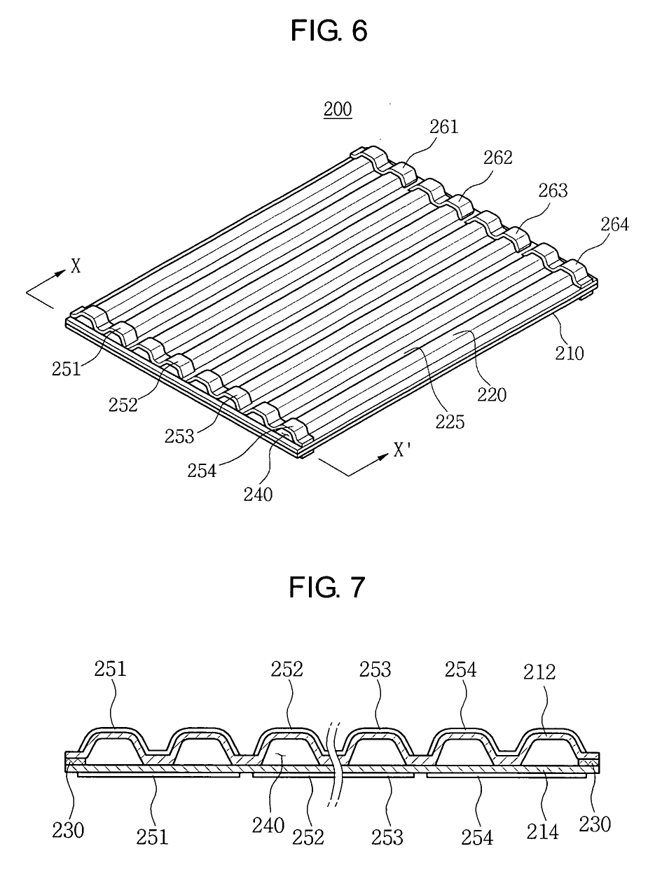

FIGS. 6 and 7 illustrate a surface light source device 200 according to a second embodiment of the present invention. The surface light source device 200 comprises a light source body 210, and a plurality of electrodes 251˜254 and 261˜264 along both edges of outer surfaces of the light source body 210.

The light source body 210 includes a first substrate 212 and a second substrate 214 which face each other and are spaced apart from each other by a predetermined distance. An inner space defined by the first and second substrates 212 and 214 is partitioned into a plurality of discharge spaces 240 by partitions 225. The partitions 225 and channels 220 may be formed, for example, by molding the first substrate 212 and/or the second substrate 214. A sealant 230 is interposed between the edges of the first and second substrates 212 and 214. A discharge gas is injected into the discharge spaces 240. A fluorescent layer (not shown) or a protection layer (not shown) may be formed inside the light source body 210, and a reflective layer (not shown) may be formed inside any one of the first substrate and the second substrate.

To drive the surface light source device 200, a plurality of the electrodes 251˜254 and 261˜264 may be formed on the first substrate 212 and/or the second substrate 214, and the discharge spaces 240 may be electrically divided into four or more blocks. The electrodes sequentially apply discharge voltages to the blocks. For example, a pair of electrodes 251 and 261, a pair of electrodes 252 and 262, a pair of electrodes 253 and 263 and a pair of electrodes 254 and 264 sequentially apply discharge voltages to the four blocks respectively.

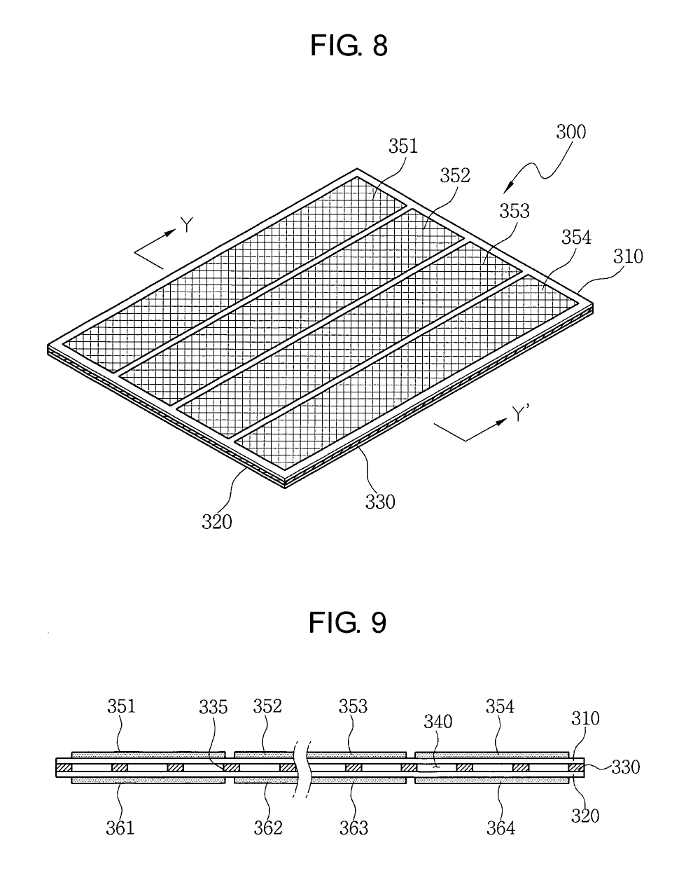

FIGS. 8 and 9 illustrate a surface light source device 300 according to a third embodiment of the present invention. The surface light source device 300 comprises a flat first substrate 310 and a flat second substrate 320. The first substrate 310 and the second substrate 320 are positioned to face each other and are spaced apart from each other by a predetermined distance. A sealing member 330 is inserted between the edges of the first and second substrates 310 and 320, to form an isolated space therebetween.

In the surface light source device 300, a plurality of electrodes 351˜354 and 361˜364 are formed on outer surfaces of a light source body. The electrodes are formed all over both outer surfaces in a shape of a plurality of face electrodes.

Preferably, the electrode may have an aperture ratio of 60% or more to increase the transmittance of light emitted from the light source body.

An inner space defined by the first substrate 310, the second substrate 320 and the sealing member 330 forms a single discharge space 340 which is not physically partitioned into a plurality of discharge spaces. The plurality of the electrodes 351˜354 and 361˜364 non-physically partition the single discharge space 340 into a plurality of blocks. Discharge voltages are sequentially applied to the blocks through the electrodes.

Since a space between the first substrate 310 and the second substrate 320 is very narrow, compared to the area of the substrates, and the inner space therebetween is formed as a single discharge space, exhaustion to vacuum and injection of a discharge gas are very easily carried out. This structure is suitable for a surface light source device using xenon, argon, neon, and other inert gas or a gas mixture thereof excluding mercury as a discharge gas. The height of the discharge space 340 between the first substrate 310 and the second substrate 320 may be determined by spacers 335.

As illustrated in FIG. 9, the surface light source device may include upper electrodes 351˜354 formed on the first substrate 310, and lower electrodes 361˜364 formed on the second substrate 320. Further, any one of the upper and lower electrodes may be formed inside the light source body.

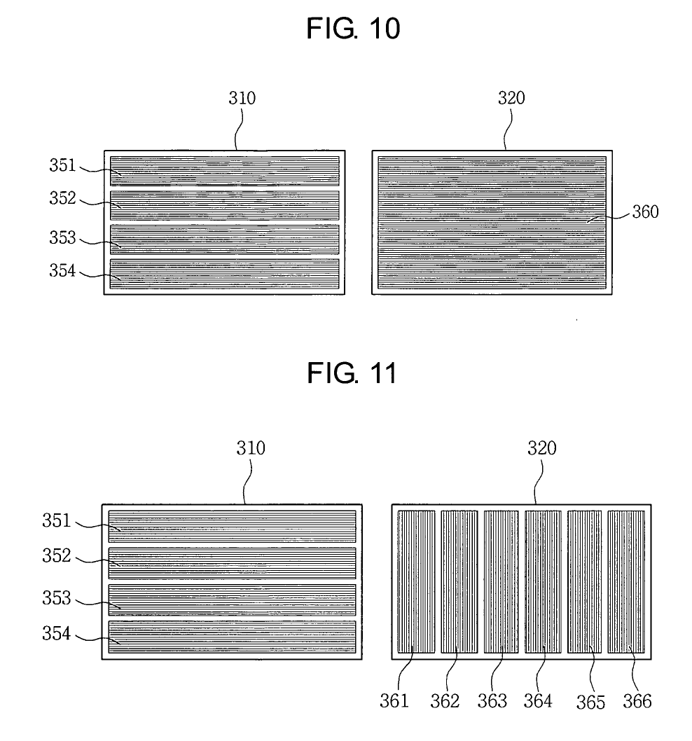

The configuration of the electrodes may be varied. For example, as illustrated in FIG. 10, a plurality of face electrodes 351˜354 may be formed on the first substrate 310 and a single face electrode 360 may be formed on the second substrate 320.

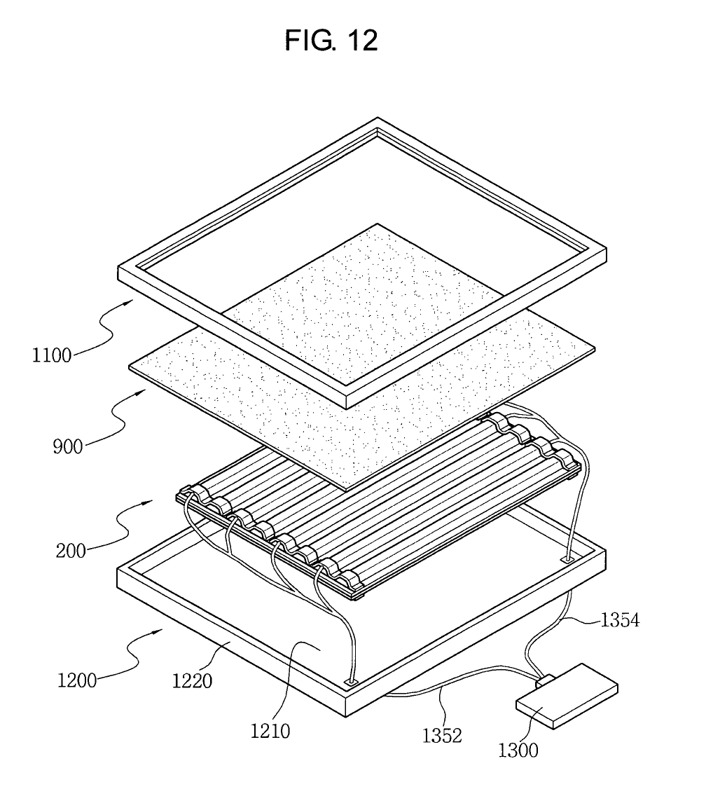

Otherwise, as illustrated in FIG. 11, a plurality of face electrodes 351˜354 may be formed on the first substrate 310, and a plurality of face electrodes 361˜364 crossing the electrodes 351˜354 may be formed on the second substrate 320.

FIG. 12 is an exploded perspective view of a backlight unit according to the present invention. As illustrated, the backlight unit comprises a surface light source device 200 including a driving unit 1300, upper and lower cases 1100 and 1200, and an optical sheet 900.

The lower case 1200 includes a bottom 1210 to receive the surface light source device 200 thereon and a plurality of sidewalls 1220 extending from edges of the bottom 1210 to form a receiving space. The surface light source device 200 is received in the receiving space of the lower case 1200.

The driving unit 1300 is positioned at the rear side of the lower case 1200 and generates discharge voltages to drive the surface light source device 200. The discharge voltages generated by the driving unit 1300 is applied to a plurality of electrodes 250 of the surface light source device 200 through first and second power lines 1352 and 1354.

The driving unit 1300 may include a sequentially driving control unit as described above. However, the sequentially driving control unit may be separated as an independent unit. The discharge voltages applied by the driving unit is sequentially applied to the electrodes, so that the surface light source device 200 divisionally and sequentially emits light.

The optical sheet 900 may include a diffusion plate to uniformly diffuse the light emitted from the surface light source device 200, and a prism sheet to make the diffused light go straight ahead. The upper case 1100 is coupled with the lower case 1200, to secure the surface light source device 200 and the optical sheet 900. The upper case 1100 prevents the surface light source device 200 from being separated from the lower case 1200.

Unlike the drawing as illustrated, the upper case 1100 and the lower case 1200 may be formed in a single integrated case. The backlight unit according to the present invention may exclude the optical sheet 900.

In accordance with the present invention, the surface light source device is sequentially driven, to reduce an after image occurring in the liquid crystal display. Furthermore, the surface light source device is divisionally driven, to reduce the power consumption, extend the lifetime and improve the image quality.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

1. A surface light source device comprising:
a light source body having an inner space therein in which a discharge gas is contained;
a plurality of electrodes formed on the light source body in such a manner as to electrically divide the inner space into at least three blocks and applying discharge voltages to the blocks; and
a driving unit sequentially applying the discharge voltages to the blocks through the electrodes in synchronization with a video signal of an external display device.

2. The surface light source device of claim 1, wherein the electrodes are formed at both ends of the blocks, and the driving unit applies anti-phase voltages to both ends of the blocks through the electrodes.

3. The surface light source device of claim 1, wherein the driving unit applies the discharge voltages in such a manner that an end point when applying a discharge voltage to a first block ends is at the same time as a start point of a vertical frequency of the video signal.

4. The surface light source device of claim 1, wherein the driving unit applies the discharge voltages in an impulse waveform with a frequency of 20˜60 kHz and an on-time of 0.1˜10 μs.

5. The surface light source device of claim 1, wherein the driving unit applies the discharge voltage to each block according to a pulse width modulation signal with a duty ratio of 50% or less.

6. The surface light source device of claim 5, wherein the driving unit varies the duty ratio within 10˜50%, depending on brightness of the video signal.

7. The surface light source device of claim 5, wherein the duty ratio is within 25 to 40%, voltage pulses with a frequency of 1 kHz or more are applied during an on-duty period, and the number of the voltage pulses is controlled depending on brightness of the video signal.

8. The surface light source device of claim 1, wherein the inner space is partitioned into a plurality of discharge spaces and a gap between the electrodes is wider than a gap between the discharge spaces.

9. The surface light source device of claim 1, wherein the light source body comprises a plurality of discharge spaces.

10. The surface light source device of claim 9, wherein the light source body comprises a first substrate and a second substrate, and at least one of the first substrate and the second substrate is molded to form the plurality of discharge spaces.

11. The surface light source device of claim 1, wherein the light source body comprises a flat first substrate and a flat second substrate between which a single discharge space is formed.

12. The surface light source device of claim 11, wherein the electrodes are formed on at least one of the first and second substrates, and an aperture ratio of the electrode is 60% or more.

13. A backlight unit comprising:
a surface light source device comprising:
a light source body having an inner space therein in which a discharge gas is contained,
a plurality of electrodes formed on the light source body in such a manner as to electrically divide the inner space into at least three blocks and applying discharge voltages to the blocks, and
a driving unit sequentially applying the discharge voltages to the blocks through the electrodes in synchronization with a video signal of an external display device; and
a case to receive the surface light source device.

14. The backlight unit of claim 13, wherein the electrodes are formed at both ends of the blocks, and the driving unit applies anti-phase voltages to both ends of the blocks through the electrodes.

15. The backlight unit of claim 13, wherein the driving unit comprises a plurality of inverters to applying the discharge voltages to the blocks through the electrodes.
